(19) United States
(12) Patent Application Publication
(10) Pub. No.: US 2007/0199799 A1
(43) Pub. Date: Aug. 30, 2007

(54) TRANSFER APPARATUS FOR TRANSFERRING IRREGULARLY CONFIGURED PRODUCTS

(75) Inventor: Masayasu KURACHI, Aichi (JP)

Correspondence Address: DENNISON, SCHULTZ & MACDONALD, 1727 KING STREET, SUITE 105, ALEXANDRIA, VA, 22314, US

(73) Assignee: YUTAKA MFG. CO., LTD., Kounan-shi, Aichi (JP)

(21) Appl. No.: 11/679,309

(22) Filed: Feb. 27, 2007

(30) Foreign Application Priority Data
Feb. 28, 2006 (JP) 2006-53179

(51) Int. Cl. B65G 47/44

(52) U.S. Cl. 198/560

(57) ABSTRACT

A transfer apparatus is used in a manufacturing process of irregularly configured products having a shell-like configuration with at least a part of its outer surface largely depressed. The transfer apparatus includes a first transfer device, a second transfer device and a supply device. A first transfer device has a gutter-like configuration and receives the products one after another while the depressions of the products being aligned with a transferring direction. The second transfer device receives the products at the depressions and transfers the products one after another in a row. The supply device receives the products from the second transfer device and supplies the products one by one to a next step.

This application claims priority to Japanese patent application serial number 2006-53179, the contents of which are incorporated herein by reference.

### BACKGROUND OF THE INVENTION

1. Field of the Invention

The present invention relates to transfer apparatus for transferring products, such as fortune cookies, having irregular configurations.

2. Description of the Related Art

Fortune cookies are known to have a shell-like configuration with a part of its outer surface largely depressed. In general, the fortune cookies are handmade and are handed to the customers at the end of the Chinese dish without being packed or with being individually packed.

In recent years, mechanization or automatization for mass production of fortune cookies has been developed. However, because the manufactured fortune cookies have irregular configurations, it is difficult to smoothly transfer the fortune cookies with the fortune cookies oriented in a predetermined direction and in a stable position during a process for packaging the individual fortune cookies after they have been manufactured. Therefore, problems have been caused during the transferring and packaging processes.

### SUMMARY OF THE INVENTION

It is an object of the present invention to teach methods that enable to smoothly transfer articles having irregular configurations with the articles oriented in a predetermined direction and in a stable position.

In a first aspect of the present teachings, transfer apparatus are taught that are used in a manufacturing process of irregularly configured products (i.e. a shell-like configuration with at least a part of its outer surface largely depressed). The transfer apparatus includes a first transfer device, a second transfer device and a supply device. The first transfer device has a gutter-like configuration and receives the products one after another while the depressions of the products are aligned with the transfer direction or oriented in the same direction as a transferring direction. The second transfer device receives the products at the depressions and transfers the products one after another in a row. The supply device receives the products from the second transfer device and supplies the products one by one to a next step.

Therefore, in order to supply the irregularly configured products, which may be manufactured or molded by a manufacturing step, to the next step, such as a packaging step, the products are received and transferred one after another by the first transfer device, while each product is positioned such that the depression is oriented in the same direction as the transferring direction. Then, the products are transferred to the second transfer device, where the products are received at the depressions and are transferred one after another in a row. Subsequently, the products are transferred to the next step by the supply device. Therefore, the products can be smoothly transferred to the supply device while the products are oriented in the same direction and each product is stably positioned.

In one embodiment, the first and second transfer devices are positioned to be inclined relative to a horizontal direction, so that the products are transferred as the products freely drop along the first and second transfer devices. With this arrangement, no drive device is needed for transferring the products by each of the first and second transfer devices. In addition, it is possible to smoothly transfer the products while the products are oriented in the same direction and each product takes is stably positioned.

In another embodiment, the first transfer device has a width that is substantially the same as a width of the product when the depression of the product is oriented in the same direction as the transferring direction. In addition, the first transfer device includes a vibrating device applying vibrations to the first transfer device, so that the position of each product is changed by the vibrations such that the orientation of the depression aligns with the transferring direction. With this arrangement, it is possible to reliably position the products such that the orientation of the depression aligns with the transferring direction.

In a further embodiment, the second transfer device includes at least one plate-like member, so that the products transferred while each product is supported in a manner like a balancing toy along the at least one plate-like member.

In a still further embodiment, the operation timing of the supply device is adjusted in response to the requirement for supplying the products to the next step. Therefore, it is possible to supply the products to the next step one after another at timing as require for the next step.

In a second aspect of the present teachings, transfer apparatus include a first transfer device, a second transfer device, a third transfer device and a supply device. The first transfer device receives and transfers products one by one, each group including the products in plural number. The second transfer device has a gutter-like configuration and receives the groups of the products one after another, so that the products are arranged and transferred in a row with the depressions aligned with the transferring direction or oriented in the same direction as the transfer direction. The third transfer device receives the products at the depressions and transfers the products one after another in a row. The supply device receives the products from the third transfer device and supplies the products one by one to a next step.

Also with this arrangement, the products can be smoothly transferred to the supply device while the products are oriented in the same direction and each product takes a stable position.

In one embodiment, the third transfer device includes a substantially elliptical belt formed by a single piece of a band plate-like member, and a drive device for circulating the belt.

### BRIEF DESCRIPTION OF THE DRAWINGS

FIG. 1 is a front view of a transfer machine according to an embodiment of the present invention;

FIG. 2 is a front view of first and second transfer devices, a distance adjusting device and a supply device of the transfer machine;

FIG. 3A is a plan view of FIG. 2;

FIG. 3B is an enlarged view of a portion indicated by a circle in FIG. 3A;

FIG. 4 is a view as viewed in a direction indicated by an arrow P in FIG. 2;

FIGS. 5(A) and 5(B) are explanatory views showing the operation for transferring products from the first transfer device to the second transfer device;

FIG. 6 is an explanatory view showing the product during the transportation by the second transfer device;

FIG. 7 is an explanatory view showing the operation for transferring the products from a receptacle to a discharge gutter;

FIG. 8 is an explanatory view showing the product during the transportation by an auxiliary transfer device;

FIGS. 9(A) and 9(B) are explanatory views showing the product during the transportation by the first transfer device;

FIG. 10 is a front view of a transfer machine according to another representative embodiment of the present invention;

FIG. 11 is a plan view of FIG. 10;

FIG. 12 is a right side view of a receptacle and first and second transfer devices shown in FIG. 10;

FIG. 13 is a detailed enlarged view of FIG. 12 and shows the relation between the receptacle and the first transfer device;

FIG. 14 is a plan view of FIG. 13;

FIGS. 15(A) and 15(B) are explanatory views showing the operation for transferring the products from the first transfer device to a second transfer device;

FIG. 16 is a schematic front view showing the relation between the second transfer device and a third transferring device;

FIG. 17 is a schematic plan view of FIG. 16;

FIG. 18 is a schematic side view of the third transfer device and showing the product during the transportation:

FIG. 19 is an enlarged explanatory view showing the product during the transportation by the third transfer device;

FIG. 20 is a plan view of the third transfer device and a next transfer device for a packaging machine and shows the operation for transferring the products;

FIG. 21 is a front view showing a supply device for supplying the products from the third transfer device to the next transfer device; and

FIG. 22 is an enlarged front view of the supply device.

### DETAILED DESCRIPTION OF THE INVENTION

Each of the additional features and teachings disclosed above and below may be utilized separately or in conjunction with other features and teachings to provide improved transfer apparatus. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

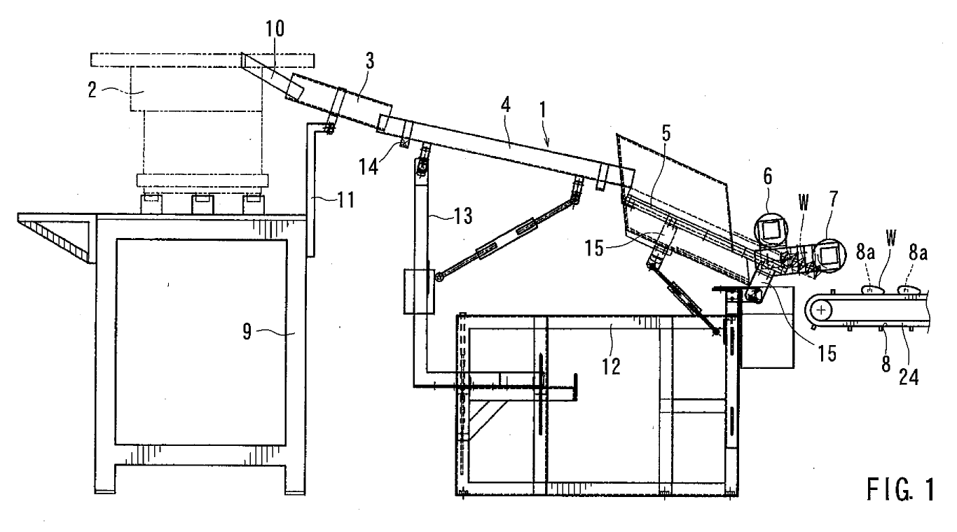

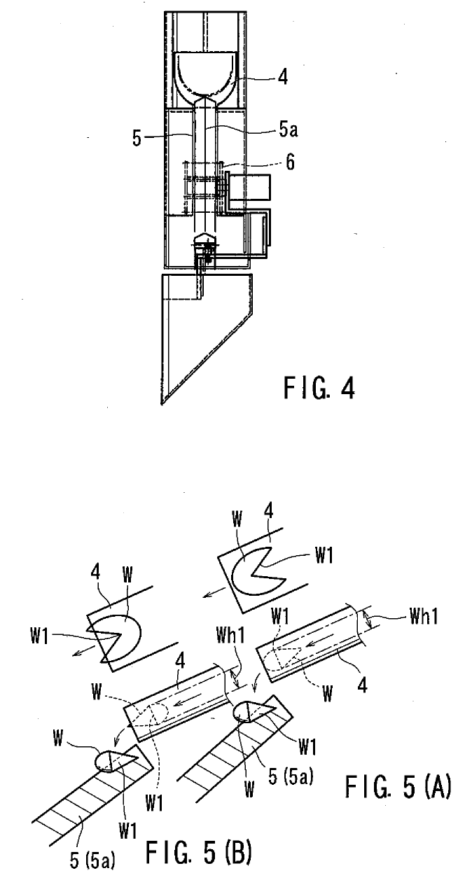

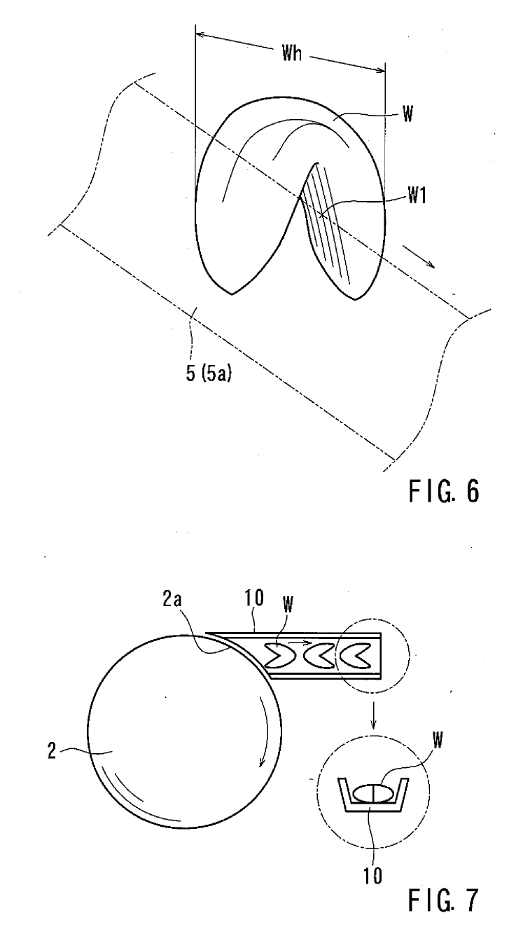

An embodiment of the present invention will now be described with reference to FIGS. 1 to 9. Referring to FIG. 1, the general construction of a representative transfer apparatus 1 is shown. This transfer apparatus 1 may be positioned between a manufacturing apparatus (not shown) for manufacturing products W, such as fortune cookies, having irregular configurations and a packaging apparatus (not shown) for individually packaging irregular products W. As shown in FIG. 6, the products W can have a shell-like configuration with a part of its outer surface largely depressed toward the core portion.

In general, the transfer apparatus 1 includes a receptacle 2 for receiving a supply of the products W manufactured by a manufacturing apparatus, so that the products W are received within the receptacle 2 and piled as a mass in which the products W are oriented in random directions. The transfer apparatus 1 further includes an auxiliary transfer device 3 for receiving the products W from the receptacle 2 and transferring therefrom, a first transfer device 4 for receiving the products W from the auxiliary transfer device 3 and transferring therefrom, a second transfer device 5 for receiving the products W from the first transfer device 4 and transferring therefrom, a distance adjusting device 6 for adjusting the distance between two adjacent individual products W that are transferred by the second transfer device 5, and a supply device 7 for supplying the products W on after another onto a transfer device 8, such as a conveyer, associated with the packaging apparatus.

Referring to FIG. 7, the receptacle 2 has a tray-like configuration and is rotatably mounted on a first base 9. A drive motor (not shown) is mounted on the first base 9, so that the receptacle 2 can be rotatably driven in one direction about a central axis. A discharge opening 2a is formed in a part of the circumferential wall of the receptacle 2, so that the products W are discharged from the discharge opening 2a one after another into a discharge gutter 10 disposed to oppose to the circumferential wall of the receptacle 2. Although not shown in the drawings, the circumferential wall of the receptacle 2 (other than the region opposing to the discharge gutter 10) is surrounded by a stationary wall that is fixed in position relative to the first base 9.

The discharge gutter 10 is positioned to extend substantially tangentially with respect to the circumferential wall of the receptacle 2 and to extend obliquely downward in a direction away from the receptacle 2. The discharge gutter 10 has a substantially U-shaped cross section and receives one product W at a time from the receptacle 2 when the discharge opening 2a of the receptacle 2 is opposed to and communicates with the discharge gutter 10. In addition, the width of a channel defined in the discharge gutter 10 is set to be substantially equal to a width Wh of the product W (see FIG. 6). Here, the width Wh is a width of the product W perpendicular to a main axis of the product W, which extends through a depression W1 of the product W. As shown in FIG. 7, during the transfer along the discharge gutter 10, the product W is oriented such that its main axis is substantially in parallel to the direction of transfer.

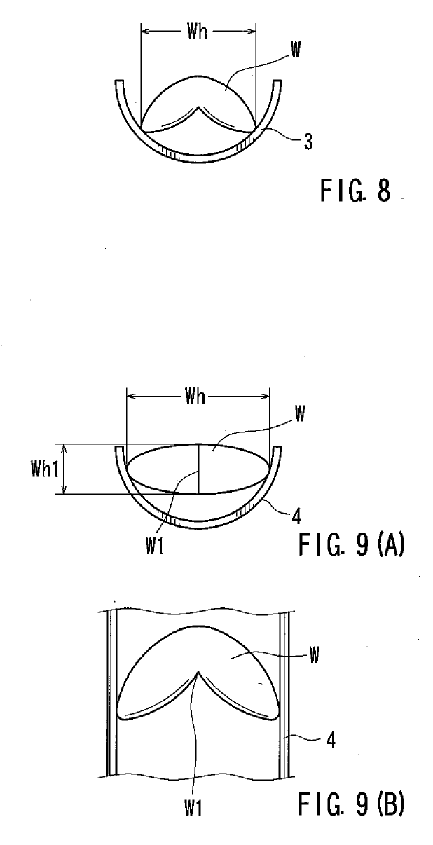

The auxiliary transfer device 3 is configured as a gutter having a substantially semicircular arc-shaped cross section (see FIG. 8) and is supported by the first base 9 via a support arm 11 so as to extend obliquely downward from the discharge gutter 10, so that the upper end of the auxiliary transfer device 3 is positioned adjacent and below the lower end of the discharge gutter 10. Therefore, the products W are transferred from the discharge gutter 10 to the auxiliary transfer device 3 and are capable of being transferred along the auxiliary transfer device 3 by a gravity force.

As shown in FIG. 8, the width of a channel defined by the auxiliary transfer device 3 is set to be larger than the width Wh of the product W, so that the products W are positioned centrally with respect to the width of the auxiliary transfer device 3 by the gravity force. Therefore, the products W are transferred along the auxiliary transfer device 3 with their main axes reliably oriented in the transfer direction.

Also, the first transfer device 4 is configured as a gutter having a substantially semicircular arc-shaped cross section (see FIGS. 9(A) and 9(B)) and is supported by a second base 12 via a substantially Y-shaped support arm 13 so as to extend obliquely downward from the auxiliary transfer device 3, so that the upper end of the first transfer device 4 is positioned adjacent below the lower end of the auxiliary transfer device 3. Therefore, the products W are transferred from the auxiliary transfer device 3 to the first transfer device 4 and are capable of being transferred along the first transfer device 4 by a gravity force.

As shown in FIG. 8, the width of a channel defined by the first transfer device 4 is set to be slightly larger than the width Wh of the product W but is smaller than the width of the auxiliary transfer device 3, so that the products W are positioned within the first transfer device 4 with their opposite ends in the widthwise direction contacting with the upper portions of the inner wall of the first transfer device 4. Also, the products W are transferred along the first transfer device 4 with their main axes reliably oriented in the transfer direction.

As shown in FIG. 1, a vibrator 14 of a desired type is attached to the first transfer device 4, so that vibrations having relatively small amplitude are applied to the entire first transfer device 4. By applying the vibrations, the position and the orientation of each product W within the first transfer device 4 can be reliably corrected, so that each product W is positioned centrally with respect to the width of the first transfer device 4 and the main axis of each product W is positioned to be parallel with the transfer direction. In other words, the products W are reliably arranged in a row along the transfer direction with their main axes oriented in the transfer direction.

The second transfer device 5 (see FIGS. 1, 3 and 4) is constituted by a single elongated plate 5a and is supported by the second base 12 via a support arm 115 so as to extend (obliquely) downward from the first transfer device 4, so that the upper end of the plate 5a is positioned adjacent to the central part of the lower end of the first transfer device 4. The plate 5a has a substantially triangular cross section with its apex oriented upward. Therefore, the products W are transferred from the first transfer device 4 to the plate 5a and are are capable of being transferred along the plate 5a by a gravity force, while the depression W1 of each product W is engaged by a linear ridge of the plate 5a. In other words, the depression W1 of products W is preferably supported by the linear ridge of the plate 5a. Preferably, an obliquely downward inclination angle of the plate 5a is set to be larger than an obliquely downward inclination angle of the first transfer device 4.

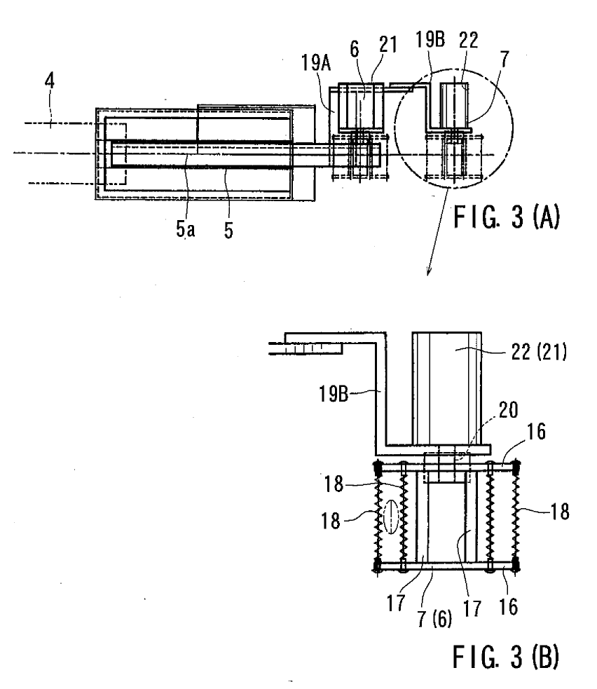

Referring to FIGS. 3(A) and 3(B), the distance adjusting device 6 and the supply device 7 are shown. The distance adjusting device 6 and the supply device 7 are basically the same in their constructions. The basic construction of these devices will be first described in connection with the supply device 7 with reference to FIGS. 3(A) and 3(B). The supply device 7 includes a pair of vertically opposing disk plates 16 spaced from each other by a predetermined distance, a plurality of retainer shafts 17 extending between the disk plates 16 and spaced equally from each other by a predetermined distance in the circumferential direction of the disk plates 16 for maintaining the predetermined distance. A plurality of distance adjusting members 18 constituted by tension coil springs extend between the outer peripheral edges of the disk plates 16 and are spaced equally from each other by a predetermined distance in the circumferential direction, which distance is slightly greater than a thickness Wh1 of the product W (see FIG. 9A). Here, the thickness Wh1 of the product W is a thickness in a direction perpendicular to the width Wh. One of the disk plates 16 is mounted to a rotary shaft 20. The distance adjusting device 6 also has the same basic construction. The distance adjusting device 6 and the supply device 7 will be further described in connection with constructions that are different from each other.

The rotary shaft 20 of the distance adjusting device 6 is coupled a first drive device 21 configured as a servo motor. The first drive device 21 is supported by the second base 12 via a bracket 19A such that the distance adjusting members 18 are positioned adjacent to and above the rear portion (right portion as viewed in FIG. 3) of the second transfer device 5 and perpendicular to the transferring direction of the products W along the second transfer device 5.

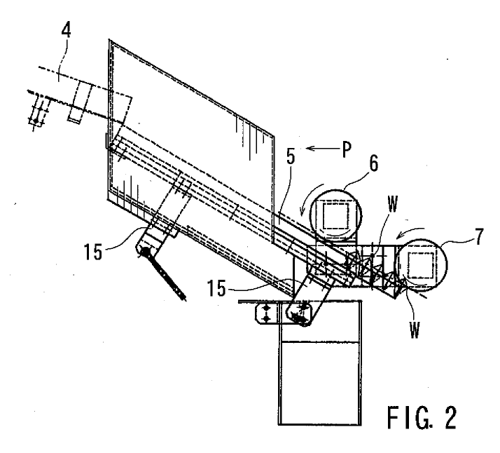

Therefore, as the distance adjusting members 18 rotate, the products W transferred along the second transfer device 5 are in turn positioned between each two adjacent pick-up members 18 and are then be released from the pick-up members 18, so that the products W are spaced equally from each other as they are transferred along the rear end of the second transfer device 5. The products W are subsequently transferred to a supply conveyer 23 (see FIG. 2).

The rotary shaft 20 of the supply device 7 is coupled to a second drive device 22 configured as a servo motor. The second drive device 22 is supported by the second base 12 via a bracket 19B such that the distance adjusting members 18 of the supply device 7 are positioned on the rear side (right side as viewed in FIG. 3) of distance adjusting members 18 of the distance adjusting device 6 and perpendicular to the transferring direction of the products W along the supply conveyer 23.

Therefore, as the distance adjusting members 18 rotate, the products W transferred along the supply conveyer 23 are in turn caught between each two adjacent pick-up members 18 and are then released from the pick-up members 18, so that the products W are fed onto the transfer device 8 associated with the packaging apparatus (see FIG. 1).

Here, the second drive device 22 as well as the first drive device 21 can be driven in synchronism with the feeding speed of the transfer device 8, so that the distance between the products W transferred along the transfer device 8 can be appropriately set.

As shown in FIG. 1, a plurality of engaging projections 8a are provided on an conveyer belt 24 and are spaced equally from each other in the transfer direction. Therefore, the engaging projections 8a may engage the depressions W1 of the products W, so that the positions of the products W along the transfer direction can be reliably determined and the products W can be reliably oriented in the same direction with each other.

As described above, according to the representative embodiment, the products W are first supplied into the receptacle 2 and are stored therein while they are oriented in random directions. As the receptacle 2 is rotatably driven by the drive device, the products W are discharged one after another into the obliquely inclined discharge gutter 10 via the discharge opening 2a.

Within the discharge gutter 10, the products W are positioned horizontally with their thickness W1 oriented substantially perpendicular to the bottom of the discharge gutter 10, although the directions of their main axes extending through the depressions W1 may not be the same with each other.

The products W may move along the discharge gutter 10 by a gravity force and may then be transferred into the auxiliary transfer device 3 and further into the first transfer device 4 by a gravity force. During the transfer along the auxiliary transfer device 3, the products are positioned substantially horizontally and centrally of the channel of the auxiliary transfer device 3 with their opposite ends in the widthwise direction contacting with the inner wall of the channel, because the channel has a semicircular arc-shaped cross section and has a width larger than the width Wh of the product W. In addition, the directions of their main axes extending through the depressions W1 of the products W may be oriented in the transfer direction or in a direction opposite to the transfer direction (see FIG. 8).

During the transfer along the first transfer device 4, due to the vibrations applied to the first transfer device 4 by the vibrator 14, the products are positioned horizontally within the channel of the first transfer device 4 with their opposite ends in the widthwise direction contacting with the upper ends of the inner wall of the channel, because the channel has a semicircular arc-shaped cross section and has a width slightly larger than the width Wh of the product W. In addition, the directions of their main axes extending through the depressions W1 of the products W can be oriented reliably in the transfer direction or substantially in a direction opposite to the transfer direction (see FIGS. 9(A) and 9(B)). In this way, the positions and orientations of the products W are adjusted and are arranged in a row along the transfer direction within the first transfer device 4.

The products W are then moved from the first transfer device 4 to the second transfer device 5 also by the gravity force. Irrespective of the orientations of the main axes of the products W during the transfer along the first transfer device 4, the positions of the products W are changed from the horizontal position to the vertical position with their depressions W1 oriented vertically downward as the products W are transferred onto the plate 5a of the second transfer device 5. Thus, as the products W move onto the plate 5a, the depressions W1 are engaged by the linear ridge of the plate 5a. The vertically positioned products W are in turn transferred rearward toward the side of the distance adjusting device 6 by a gravity force.

The products W transferred rearward along the plate 5a are in turn caught between each two adjacent distance adjusting members 18 and are then released as the distance adjusting members 18 are rotated by the first drive device 21 in synchronism with the second drive device 22 of the subsequent supply device 7. Thus, the distance between two adjacent products W depends on the rotational speed of the distance adjusting members 18.

The products W are subsequently transferred to the supply device 7 and are in turn caught between each two adjacent distance adjusting members 18 and are then released as the distance adjusting members 18 are rotated by the second drive device 22, which can be driven in synchronism with the first drive device 22 of the distance adjusting device 7. Also, the distance between two adjacent products W depends on the rotational speed of the distance adjusting members 18. The products W are then moved from the supply device 7 onto the transfer device 8 of the packaging apparatus.

Because the first and second drive devices 21 and 22 are driven in synchronism with the moving speed of the conveyer belt 24 of the transfer device 8, the depressions W1 of the products W supplied from the supply device 7 are in turn reliably engaged by the engaging projections 8a provided on the conveyer belt 24, so that the products W are moved while they are positioned horizontally and spaced equally from each other in the transfer direction with their depressions W1 oriented in the same direction.

In this way, the products W (supplied into the receptacle 2) can be eventually moved to the packaging apparatus with the products W spaced equally from each other, positioned horizontally and oriented in the same direction. As a result, the packaging operation of the products W by the packaging apparatus can be smoothly and efficiently performed.

Although the above embodiment has been described in connection with fortune cookies as an example of the products W, the above embodiment can be applied to any other products as long as they have depressions formed in their outer surfaces.

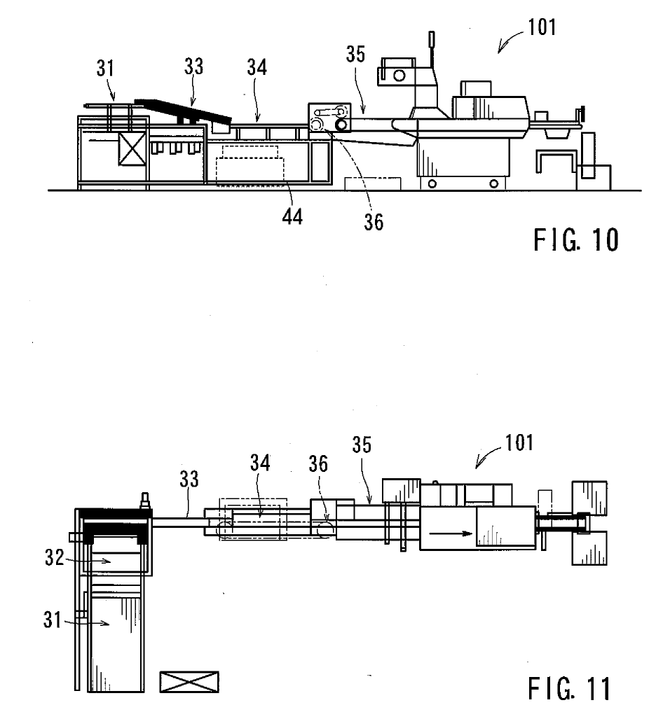

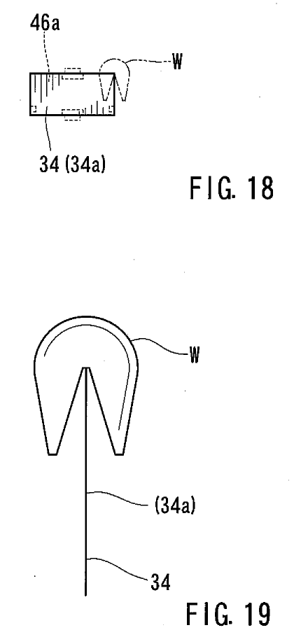

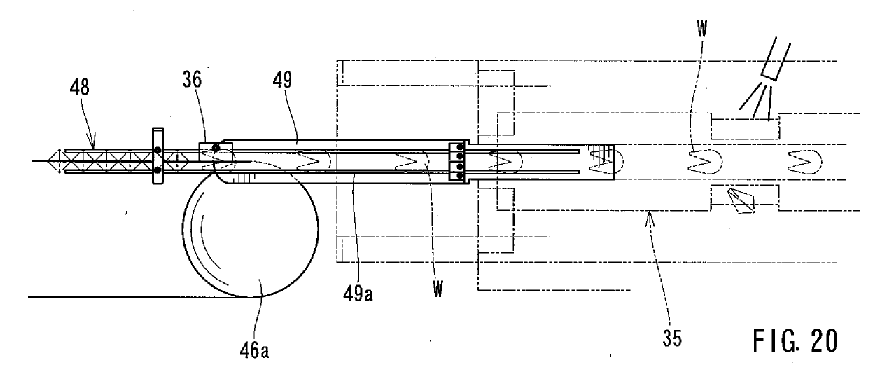

A second representative embodiment will now be described with reference to FIGS. 10 to 22. A transfer apparatus 101 according to this embodiment is also designed to transfer the products W having irregular configurations shown in FIG. 6 in connection with the first representative embodiment. Referring to FIGS. 10 and 11, the transfer apparatus 101 generally include a receptacle 31 for receiving a supply of the products W manufactured by the manufacturing apparatus, so that the products W are received within the receptacle 31 and are oriented in random directions. The transfer apparatus 101 further includes a first transfer device 32 for receiving the products W from the receptacle 31 and transferring therefrom, a second transfer device 33 for receiving the products W from the first transfer device 32 and transferring therefrom, a fourth transfer device 34 for receiving the products W from the third transfer device 33 and transferring therefrom, a supply device 36 for supplying the products W one after another onto a transfer device 35, such as a conveyer, associated with the packaging apparatus.

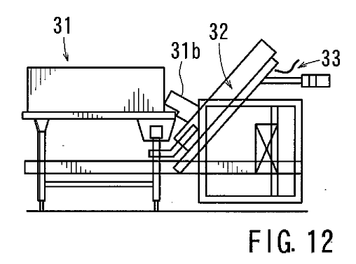

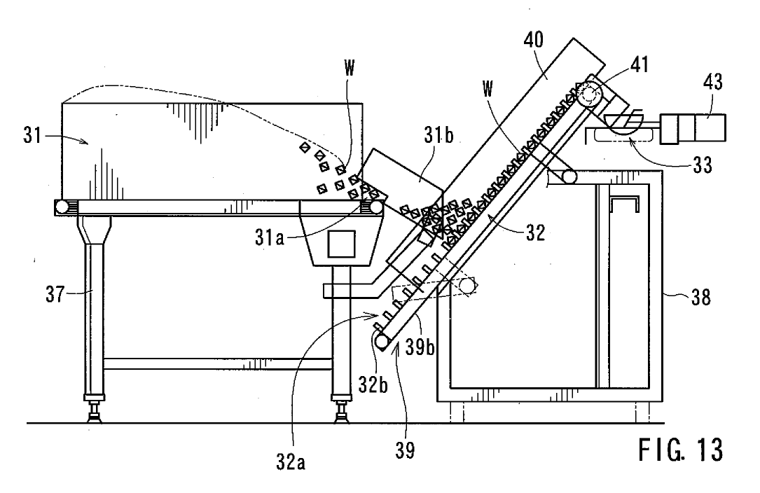

As shown in FIGS. 12 and 13, the receptacle 31 is disposed on a base 37 and has an upper opening for receiving the products W. An opening 31a is formed on one side of the receptacle 31 throughout the entire height of the receptacle 31. Gutter 31b can have a tubular configuration and be attached to the base 37 so as to extend obliquely downward from the receptacle 31. The gutter 31b has an open upper side and upper and lower open ends in the lengthwise direction. The upper open end of the gutter 31b is positioned to communicate with the opening 31a of the receptacle 31 and the lower open end is positioned adjacent to the first transfer device 32.

The first transfer device 32 includes a conveyer 39 and side plates 40 disposed on both sides of the conveyer 39. The conveyer 39 has a belt 39b and is supported on a base 38 such that the belt 39b is positioned obliquely upward in a right direction as viewed in FIGS. 11 and 12. Also, the side plates 40 are mounted to the base 38. The base 38 is positioned to oppose to the base 37. The belt 39b is driven to circulate by a drive motor 41. A plurality of projections 32a are formed on the surface of the belt 39b and are elongated in the widthwise direction of the belt 39b, so that a plurality of receiving recesses 32a elongated in the widthwise direction are formed between the projections 32a and arranged in row. The lower open end of the gutter 31b is positioned to oppose to the lower portion of the belt 39b from the upper side.

Therefore, the products W transferred from the gutter 31b are received within the receiving recesses 32a of the conveyer belt 39b, so that the products W received within each receiving recess 32a are arranged in a row in the widthwise direction of the conveyer belt 39b. As the conveyer belt 39b is driven, the products W received within each receiving recess 32a are conveyed upward and are then supplied to the second transfer device 33.

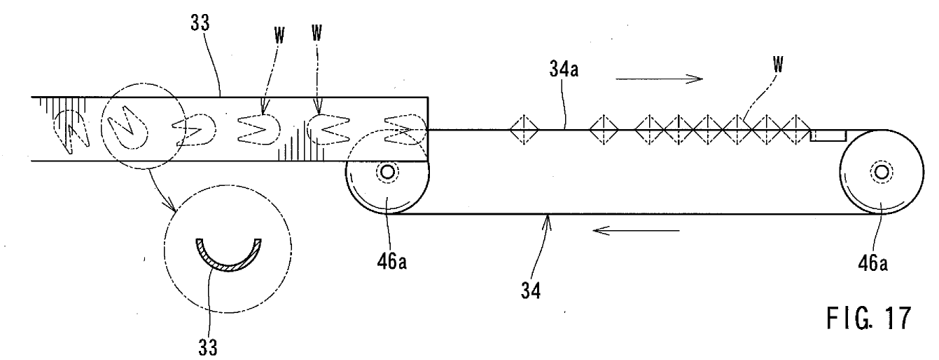

As shown in FIGS. 13 and 17, the second transfer device 33 is configured as a gutter having a substantially semicircular arc-shaped cross section and extends in a direction perpendicular to the transfer direction of the products W along the conveyer belt 39b. The second transfer device 33 is supported by the base 38 via a frame (not shown) and has opposite ends. One end of the second transfer device 33 is positioned adjacent to and below the upper end of the first transfer device 32. The other end of the second transfer device 33 is positioned adjacent to the third transfer device 34.

Preferably, the second transfer device 33 extends obliquely downward toward the third transfer device 34, so that the products W supplied from the conveyer 39 can be moved along the second transfer device 33 by a gravity force. Further, the width of a channel defined by the second transfer device 33 is set to be larger than the width Wh of the products W, so that the products W are positioned centrally with respect to the width of the second transfer device 33 by the gravity force. Therefore, as the products W are transferred along the second transfer device 33, the main axes of the products W may be oriented in the transfer direction.

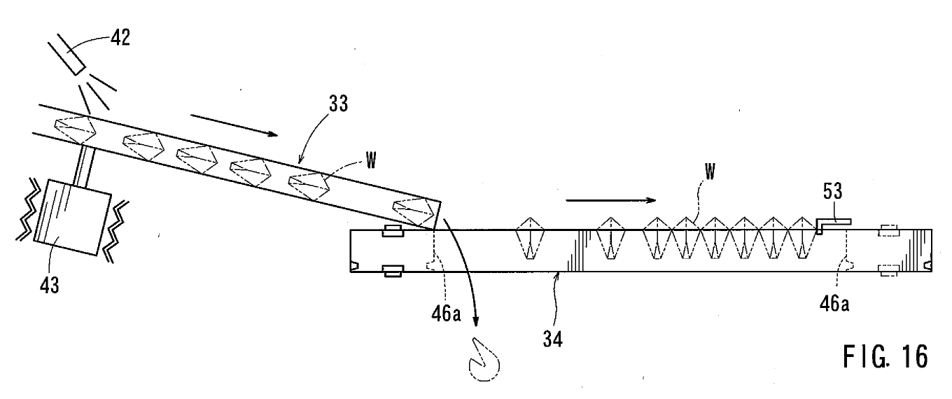

As shown in FIG. 16, an air blowing device 42 is provided in order to apply a flow of air to the products W from the upper side during the transfer along the second transfer device 33, so that the products W are forced to move along the second transfer device 33 to cope with the transfer requirement for the third transfer device 34. In addition, a vibrator 43 is attached to the second transfer device 33 for reliably orienting the main axes of the products W in the transfer direction.

The third transfer device 34 has a single piece of a band plate-like member 34a having a predetermined thickness and formed into an belt moving along a substantially elliptical closed path with substantially semicircular opposite ends and a pair of parallel linear paths. The band plate-like member 34a extends between a pair of guide pulleys 46a, which are supported by a base 44 (see FIG. 10) and the defining the opposite ends of the moving path, so that one of the parallel moving paths is positioned below the central portion of the discharge side end of the second transfer device 33. A drive motor 45 drives one or both of the drive pulleys 46a, so that the band plate-like member 34a circulates along the elliptical closed path. The upper edge of the band plate-like member 34a receives the products W from the second transfer device 33 such that the depressions W1 of the products W engage the upper edge of the band-like member 34 and are supported in a manner similar to a balancing toy. Then, the products W are transferred along the moving path of the band plate-like member 34a.

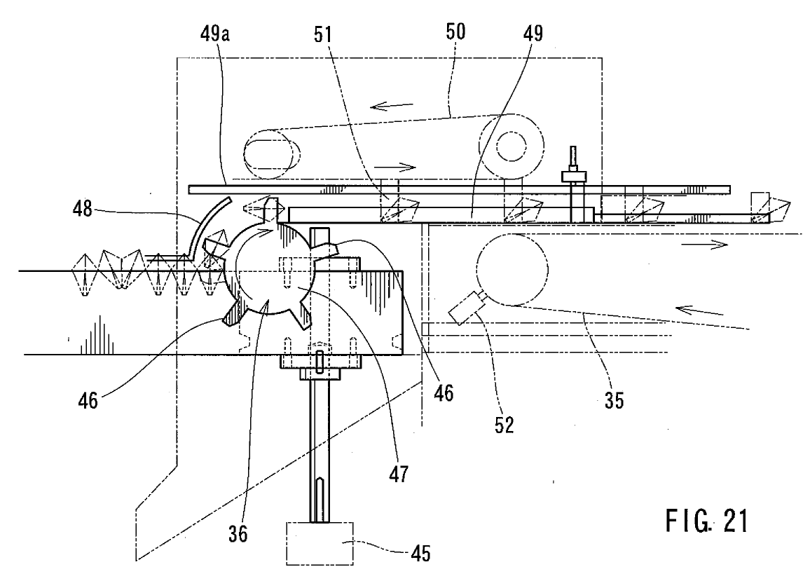

As shown in FIG. 21, the supply device 36 has a supply disk 47 as a primary element. A plurality of take-up claws 46 (four take-up claws 46 are provided in this embodiment) are formed on the outer circumference of the supply disk 47. The supply disk 47 is positioned opposed to and proximally from the downstream side end of the one of the parallel paths of the band plate-like member 34a. In addition, the supply disk 47 is rotatably driven by a motor (not shown). Therefore, as the supply disk 47 rotates, the take-up claws 46 engage the depressions W1 of the products W moving along with the band plate-like member 34a and take up the products W from the band plate-like member 34a. As the supply disk 47 further rotates, the products W are released from the take-up claws 46 and are then supplied to the transfer device 35, such as a conveyer, for the packaging step.

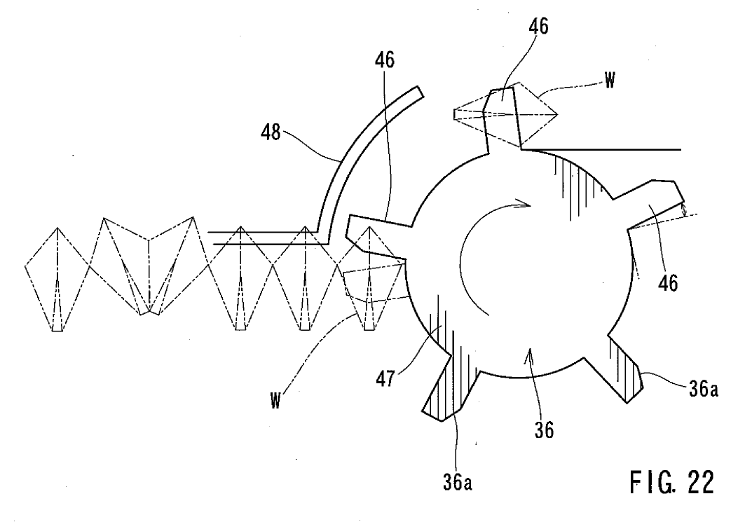

As shown in FIG. 22, one of side edges of a tip end of each take-up claw 46 is formed with a relief face 36a in order to prevent the tip end from contacting with the product W to be received by the next take-up claw 36. The other of the side edges of the tip end is inclined by a predetermined angle relative to a radial direction of the supply disk 47, so that the products W can be smoothly received by the take-up claw 36.

Further, as shown in FIG. 22, a substantially L-shaped guide plate 48 is disposed proximally to and slightly above the downstream side end of the band plate-like member 34a of the third transfer device 34 and extends along a part of the outer periphery of the supply disk 47 while maintaining a suitable distance therefrom. Therefore, the products W that have moved along the band plate-like member 34a of the third transfer device 34 will not move away from the band plate-like member 34a and will not be disengaged from the take-up claws 46 of the supply disk 47 during the transportation by the supply disk 47.

A lower guide plate 49 and a pair of rail-like upper guide plates 49a spaced vertically relative to the lower guide plate 49 are disposed over and between the transfer device 35 for the packaging step and the supply device 36. A transfer conveyer 50 having an belt that is driven to circulate is disposed above the upper guide plates 49a in order to receive the products W from the take-up claws 46 of the supply disk 47. Thus, a plurality of feeding claws 51 are provided on the belt of the transfer conveyer 50 and protrude therefrom. The feeding claws 51 are spaced from each other by a distance corresponding to the distance between two adjacent take-up claws 46.

As a result, the feeding claws 51 of the transfer conveyer 50 receive the products W from the take-up claws 46 and then feed the products W into a feeding space between the lower guide plate 49 and the upper guide plates 49a, so that the products W are moved along the feeding space by the conveyer 50 to be transferred onto the transfer device 35.

The transfer device 35 has a conveyer belt on which feeding claws 52 are formed, so that the feeding claws 52 engage the products W that have been moved along the feeding space between the lower guide plate 49 and the upper guide plates 49a. The products W engaged by the feeding claws 52 are transferred by the conveyer belt and are then supplied to a packaging machine for the packaging step.

The movement of the feeding claws 52 of the transfer device 35, the movement of the feeding claws 51 of the conveyer belt 50, and the movement of the take-up claws 46 of the supply disk 47 can be synchronized with each other for smoothly performing the transfer operation of the products W.

As shown in FIG. 16, a movable stopper 53 is disposed on the band plate-like member 34a of the third transfer device 34 in a position proximally to the downstream side end of the third transfer device 34. The movable stopper 53 is movable into and away from the traveling path of the products W along the band plate-like member 34a, so that the products W can be accumulated on the band plate-like member 34a when the stopper 53 has moved into the traveling path of the products W.

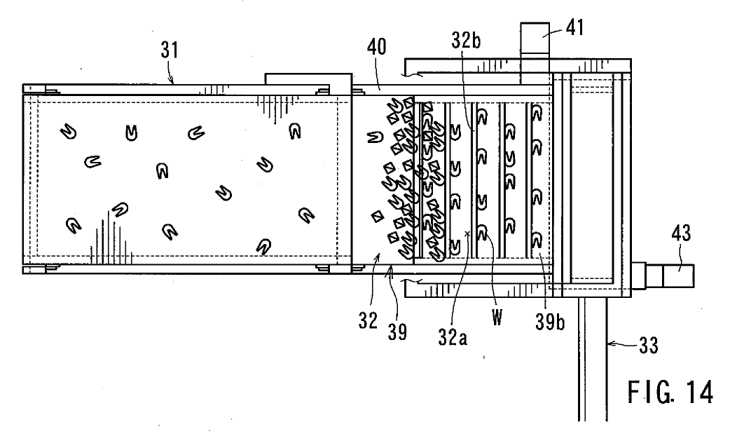

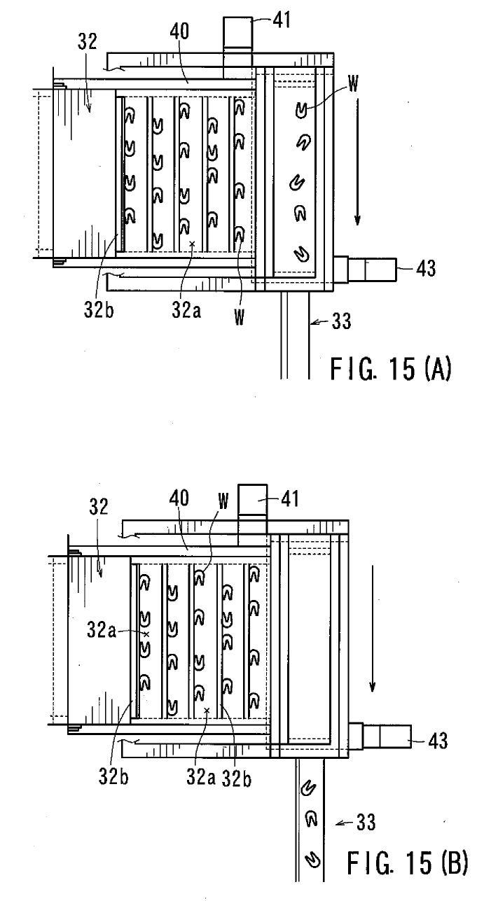

According to the second representative embodiment as described above, the products W are received within the receptacle 31 and are oriented in random directions. The products W are then transferred to the first transfer device 32 from the receptacle 31 via the opening 31a formed in the receptacle and the gutter 31b. The first transfer device 32 has a plurality of receiving recesses 32a defined between the projections 32a formed on the belt 39b, so that the products W are received within each receiving recess 32a and are arranged in a row in the crosswise direction (see FIGS. 14 and 15). The products W are then transferred upward as the belt 39b rotates and the rows of the products W are subsequently supplied one after another into the second transfer device 33. The width of the channel defined by the second transfer device 33 is slightly larger than the width Wh of the product W when the depression W1 of the product W is oriented in the transfer direction of the second transfer device 33. In addition, the channel of the second transfer device 33 has a semicircular arc shaped configuration. Therefore, during the transportation, each product W is turned horizontally with its main axis oriented in the same direction as the transfer direction or the direction opposite to the transfer direction during transportation while the product W is positioned centrally with respect to the width of the second transfer device 33 by a gravity force (see FIG. 15b, 16 and 17).

The products W are further transferred from the second transfer device 33 to the third transfer device 34, where the products W are supported at their depressions W1 by the linear upper edge of the band plate-like member 34a that is driven to circulate by the motor 45 (see FIGS. 16 and 17). During the transportation, the products W are arranged in a row and spaced approximately equally from each other. The products W are thus moved toward the supply device 36 by the third transfer device 34.

The take-up claws 46 of the supply disk 47 of the supply device 36 in turn engage the depressions W1 of the products W, which have been transferred by the band plate-like member 34a of the third transfer device 34, from their lower side and take up the products W.

The products W are then engaged by the feeding claws 51 of the conveyer 50 and are moved to the transfer device 35, while the products W move within the space defined between the lower guide plates 49 and the upper guide plate 49a. Thus, the products W transferred by the conveyor 50 are engaged by the feeding claws 52 of the transfer device 35 and are then supplied to the packaging machine.

As a result, the products W are transferred to the packaging machine one after another while the products W are oriented horizontally with their depressions W1 oriented in the same direction as the transferring direction. Therefore, it is possible to smoothly and rapidly transfer the products W into the packaging machine, and consequently, it is possible to smoothly perform the packaging operation and to improve the operation efficiency of the packaging operation.

This invention claims:

1. A transfer apparatus for a manufacturing process of irregularly configured products having a shell-like configuration, comprising:
a first transfer device having a U-shaped configuration, wherein the first transfer device is capable of receiving products having a depression, wherein the depressions of the products are aligned with a transferring direction;
a second transfer device structured to receive the products at the depressions and to transfer the products in a row; and
a supply device arranged and constructed to receive the products from the second transfer device and to supply the products to a next step.

2. The transfer apparatus as in claim 1, wherein the first and second transfer devices are positioned and structured to be inclined relative to a horizontal direction, so that the products are transferred as the products freely drop along the first and second transfer devices.

3. The transfer apparatus as in claim 1, wherein:
the first transfer device has a width that is substantially the same as a width of the product when the depression of the product is aligned with the transferring direction, and the first transfer device includes a vibrating device capable of applying vibrations to the first transfer device, so that the position of each product is changed by the vibrations such that the orientation of the depression aligns with the transferring direction.

4. The transfer apparatus as in claim 1, wherein the second transfer device comprises at least one plate-like member, capable of supporting the product along the at least one plate-like member.

5. The transfer apparatus as in claim 1, wherein the operation timing of the supply device is adjusted in response to the requirement for supplying the products to the next step.

6. A transfer apparatus used in a manufacturing process of irregularly configured products having a shell-like configuration, comprising:
a first transfer device arranged and constructed to receive and transfer plurality of groups, each plurality of groups including the a plurality of products, wherein each of the plurality of products includes a depression;
a second transfer device having a gutter-like configuration capable of receiving the plurality of groups one after another, so that the plurality of products are arranged and transferred in a row with the depressions aligned with the transfer direction;
a third transfer device arranged and constructed to receive the plurality of products at the depressions and to transfer the products one after another in a row; and
a supply device arranged and constructed to receive the plurality of products from the third transfer device and to supply the plurality of products one by one to a next step.

7. The transfer apparatus as in claim 6, wherein the third transfer device comprises a substantially elliptical belt formed by a single piece of a band plate-like member, and a drive device for circulating the belt.

8. The transfer apparatus as in claim 6, wherein the first and second transfer devices are positioned and structured to be inclined relative to a horizontal direction.

9. The transfer apparatus as in claim 6, wherein the first transfer device includes a plurality of projections structured to support the plurality of products.

10. The transfer apparatus as in claim 9, wherein the second transfer device includes a vibrating device capable of applying vibrations to the second transfer device.

11. The transfer apparatus as in claim 6, further including an air blowing device positioned adjacent the second transfer device.

12. The transfer apparatus as in claim 6, wherein the third transfer device includes a plate capable of supporting the plurality of products.

13. A transfer apparatus structured to transfer irregularly configured products:
a first transfer device having a U-shaped configuration, wherein the first transfer device is capable of receiving products having a depression, wherein the depression of the product is aligned with a transferring direction;
a second transfer device including a plate structured to receive the product at the depressions;
a supply device arranged and constructed to receive the products from the second transfer device and to supply the products to a next device.

14. The transfer apparatus as in claim 13, wherein the plate is shaped like a triangle.

15. The transfer apparatus as in claim 13, wherein the plate extends along an entire length of the second transfer device.

16. The transfer apparatus as in claim 13, wherein the first and second transfer devices are positioned and structured to be inclined relative to a horizontal direction.

17. The transfer apparatus as in claim 13, wherein the first transfer device has a width that is substantially the same as a width of the product and the first transfer device includes a vibrating device capable of applying vibrations to the first transfer device.

18. The transfer apparatus as in claim 13, wherein the second transfer device comprises at least one plate-like member, capable of supporting the product along the at least one plate-like member.

19. The transfer apparatus as in claim 13, wherein the operation timing of the supply device is adjusted in response to the requirement for supplying the products to the next step.
